(19) United States
(12) Patent Application Publication
(10) Pub. No.: US 2025/0363012 A1
(43) Pub. Date: Nov. 27, 2025

(54) MACHINE LEARNING-BASED MANAGEMENT OF BACKUP OPERATIONS

(71) Applicant: Dell Products L.P., Round Rock, TX (US)

(72) Inventors: Yuvaraj Muthusamy, Bangalore (IN); Sriram Subramanian, Bangalore (IN); Parminder Singh Sethi, Ludhiana (IN); Mohit Kumar Agarwal, Cyberjaya (MY)

(21) Appl. No.: 18/673,845

(22) Filed: May 24, 2024

(51) Int. Cl. G06F 11/14

(52) U.S. Cl. CPC G06F 11/1461; G06F 11/1464; G06F 2201/84

(57) ABSTRACT

An apparatus comprises at least one processing device configured to identify a plurality of backup operations to be performed in a backup infrastructure environment comprising two or more backup servers, to generate a first data structure characterizing a prioritization of at least a subset of the plurality of backup operations, and to generate a second data structure characterizing status of the two or more backup servers in the backup infrastructure environment. The at least one processing device is also configured to determine, utilizing at least one machine learning model that is implemented by the at least one processing device and that takes as input the first data structure and the second data structure, an execution schedule for the subset of the plurality of backup operations, and to execute the subset of the plurality of backup operations in the backup infrastructure environment in accordance with the determined execution schedule.

### BACKGROUND

As the value and use of information continues to increase, individuals and businesses seek additional ways to process and store information. Information processing systems may be used to process, compile, store and communicate various types of information. Because technology and information processing needs and requirements vary between different users or applications, information processing systems may also vary (e.g., in what information is processed, how the information is processed, how much information is processed, stored, or communicated, how quickly and efficiently the information may be processed, stored, or communicated, etc.). Information processing systems may be configured as general purpose, or as special purpose configured for one or more specific users or use cases (e.g., financial transaction processing, airline reservations, enterprise data storage, global communications, etc.). Information processing systems may include a variety of hardware and software components that may be configured to process, store, and communicate information and may include one or more computer systems, data storage systems, and networking systems.

### SUMMARY

Illustrative embodiments of the present disclosure provide techniques for machine learning-based management of backup operations.

In one embodiment, an apparatus comprises at least one processing device comprising a processor coupled to a memory. The at least one processing device is configured to identify a plurality of backup operations to be performed in a backup infrastructure environment, the backup infrastructure environment comprising two or more backup servers, to generate a first data structure characterizing a prioritization of at least a subset of the plurality of backup operations, and to generate a second data structure characterizing status of the two or more backup servers in the backup infrastructure environment. The at least one processing device is also configured to determine, utilizing at least one machine learning model that is implemented by the at least one processing device and that takes as input at least a portion of the first data structure and at least a portion of the second data structure, an execution schedule for the subset of the plurality of backup operations, and to execute the subset of the plurality of backup operations in the backup infrastructure environment in accordance with the determined execution schedule.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based management of backup operations in an illustrative embodiment.

FIG. 2 is a flow diagram of an exemplary process for machine learning-based management of backup operations in an illustrative embodiment.

FIG. 3 shows a system configured for performing backup operations in an illustrative embodiment.

FIG. 4 shows the system of FIG. 3 implementing a deep reinforcement learning-based backup operation scheduling and optimization tool for scheduling of the backup operations in an illustrative embodiment.

FIG. 5 shows a process flow for backup operation scheduling utilizing the deep reinforcement learning-based backup operation scheduling and optimization tool of FIG. 4 in an illustrative embodiment.

FIG. 6 shows model notation for a deep reinforcement learning-based backup operation scheduling model in an illustrative embodiment.

FIG. 7 shows an architecture of a deep reinforcement learning-based backup operation scheduling model in an illustrative embodiment.

FIG. 8 shows a scheduling time model for use in a deep reinforcement learning-based backup operation scheduling model in an illustrative embodiment.

FIG. 9 shows an architecture of an actor-critic algorithm implemented in a deep reinforcement learning-based backup operation scheduling model in an illustrative embodiment.

FIG. 10 shows a process flow for training a deep reinforcement learning-based backup operation scheduling model in an illustrative embodiment.

FIG. 11 shows parameter values utilized for a deep reinforcement learning-based backup operation scheduling model in an illustrative embodiment.

FIGS. 12A and 12B show loss trend and reward trend graphs for backup operation scheduling utilizing a deep reinforcement learning-based backup operation scheduling model and a first come first serve scheduling algorithm in an illustrative embodiment.

FIGS. 13A and 13B show plots comparing average task delay and average task priority for backup operation scheduling utilizing a deep reinforcement learning-based backup operation scheduling model and a first come first serve scheduling algorithm in an illustrative embodiment.

FIG. 14 shows a plot of task congestion degree in an illustrative embodiment.

FIGS. 15 and 16 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

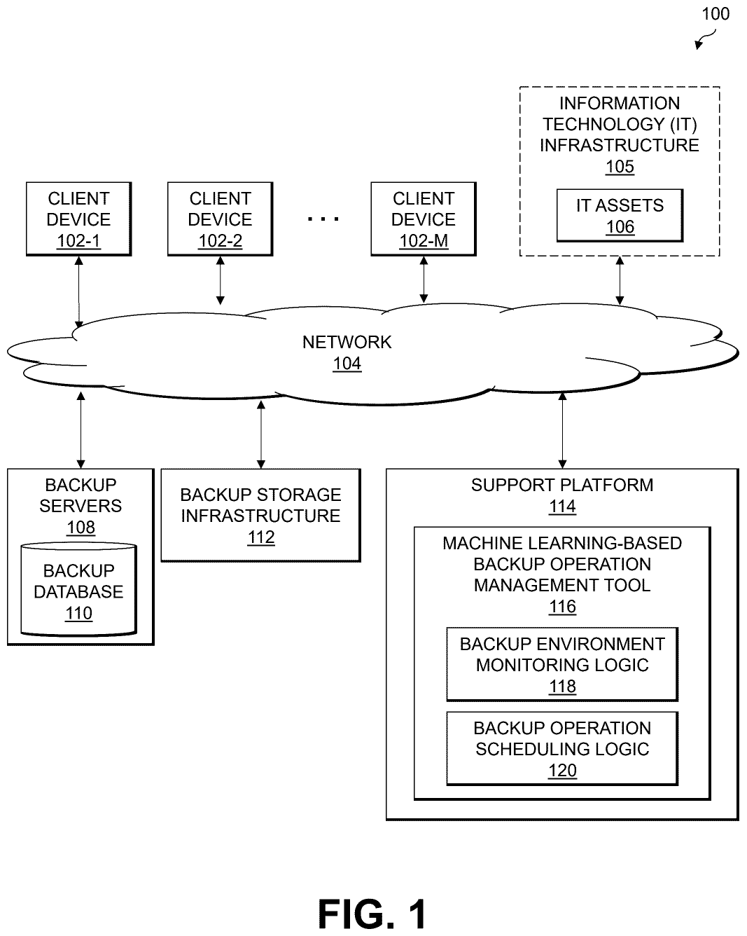

FIG. 1 shows an information processing system 100 configured in accordance with an illustrative embodiment. The information processing system 100 is assumed to be built on at least one processing platform and provides functionality for machine learning-based management of backup operations. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, one or more backup servers 108 comprising a backup database 110, a backup storage infrastructure 112, and a support platform 114. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc. Although shown as separate in FIG. 1 for clarity of illustration, in some embodiments the backup servers 108, the backup database 110, the backup storage infrastructure 112 and/or the support platform 114 may be implemented internal to the IT infrastructure 105. For example, the backup servers 108, the backup database 110, the backup storage infrastructure 112 and/or the support platform 114 may run on IT assets 106 of the IT infrastructure 105.

In some embodiments, the support platform 114 is used for an enterprise system. For example, an enterprise may subscribe to or otherwise utilize the support platform 114 for managing backup operations (e.g., which may be triggered by the client devices 102 and/or IT assets 106 of the IT infrastructure 105) of an enterprise, organization or other entity. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The backup servers 108 are configured to coordinate backup operations which are triggered or otherwise initiated by the client devices 102 and/or the IT assets 106, and which are performed to back up data (e.g., stored on the client devices 102 and/or the IT assets 106) on the backup storage infrastructure 112. The backup storage infrastructure 112 may comprise one or more storage systems or servers, including on-premises or off-premises storage servers (e.g., including cloud-based storage) on which backups are stored. The backup database 110 is configured to store and record various information that is utilized by the backup servers 108 (as well as the support platform 114) for such coordination of backup operations. Such information may include, for example, information related to current and historical backup operations, available storage systems or servers in the backup storage infrastructure 112, monitoring information related to a backup environment (e.g., the backup servers 108 and/or the backup storage infrastructure 112), etc. The backup database 110 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the support platform 114, as well as to support communication between the support platform 114 and other related systems and devices not explicitly shown.

The support platform 114 may be provided as a cloud service that is accessible by one or more of the client devices 102 to allow users thereof to manage backup operations of an enterprise, organization or other entity. In some embodiments, the client devices 102 are assumed to be associated with system administrators, IT managers or other authorized personnel responsible for managing one or more databases or other source of information of an enterprise, organization or other entity. In some embodiments, the client devices 102 are utilized by members of the same enterprise, organization or other entity that operates the support platform 114. In other embodiments, the client devices 102 are utilized by members of one or more enterprises, organizations or other entities different than the enterprise, organization or other entity that operates the support platform 114 (e.g., a first enterprise provides support functionality for multiple different customers, businesses, etc.). Various other examples are possible.

In some embodiments, the client devices 102 and/or the IT assets 106 of the IT infrastructure 105 may implement host agents that are configured for automated transmission of information with the backup servers 108 and the support platform 114 regarding backup operations of an enterprise, organization or other entity. It should be noted that a “host agent” as this term is generally used herein may comprise an automated entity, such as a software entity running on a processing device. Accordingly, a host agent need not be a human entity.

The support platform 114 in the FIG. 1 embodiment is assumed to be implemented using at least one processing device. Each such processing device generally comprises at least one processor and an associated memory, and implements one or more functional modules or logic for controlling certain features of the support platform 114. In the FIG. 1 embodiment, the support platform 114 implements a machine learning-based backup operation management tool 116. The machine learning-based backup operation management tool 116 comprises backup environment monitoring logic 118 and backup operation scheduling logic 120. The backup environment monitoring logic 118 is configured to monitor a backup environment (e.g., the backup servers 108 and the backup storage infrastructure 112). This may include, for example, monitoring incoming and ongoing backup operations which are performed by the backup servers 108 (e.g., as triggered by the client devices 102 and/or the IT assets 106) utilizing the backup storage infrastructure 112. This may also include monitoring resource usage or other performance of the backup servers 108 and the backup storage infrastructure 112. The backup operation scheduling logic 120 is configured to implement one or more machine learning models configured to utilize the monitored backup environment information to schedule backup operations for execution by the backup servers 108. In some embodiments, the backup operation scheduling logic 120 implements a reinforcement deep learning framework for determining the backup operation scheduling.

At least portions of the machine learning-based backup operation management tool 116, the backup environment monitoring logic 118 and the backup operation scheduling logic 120 may be implemented at least in part in the form of software that is stored in memory and executed by a processor.

It is to be appreciated that the particular arrangement of the client devices 102, the IT infrastructure 105, the backup servers 108, the backup database 110, the backup storage infrastructure 112, and the support platform 114 illustrated in the FIG. 1 embodiment is presented by way of example only, and alternative arrangements can be used in other embodiments. As discussed above, for example, the support platform 114 (or portions of components thereof, such as one or more of the machine learning-based backup operation management tool 116, the backup environment monitoring logic 118 and the backup operation scheduling logic 120) may in some embodiments be implemented internal to the IT infrastructure 105, internal to the backup servers 108, etc.

The support platform 114 and other portions of the information processing system 100, as will be described in further detail below, may be part of cloud infrastructure.

The support platform 114 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the backup servers 108, the backup database 110, the backup storage infrastructure 112 and the support platform 114 or components thereof (e.g., the machine learning-based backup operation management tool 116, the backup environment monitoring logic 118 and the backup operation scheduling logic 120) may be implemented on respective distinct processing platforms, although numerous other arrangements are possible. For example, in some embodiments at least portions of the support platform 114 and one or more of the client devices 102, the IT infrastructure 105, the IT assets 106 and/or the backup database 110 are implemented on the same processing platform. A given client device (e.g., 102-1) can therefore be implemented at least in part within at least one processing platform that implements at least a portion of the support platform 114.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the backup servers 108, the backup database 110, the backup storage infrastructure 112 and the support platform 114, or portions or components thereof, to reside in different data centers. Numerous other distributed implementations are possible. The support platform 114 can also be implemented in a distributed manner across multiple data centers.

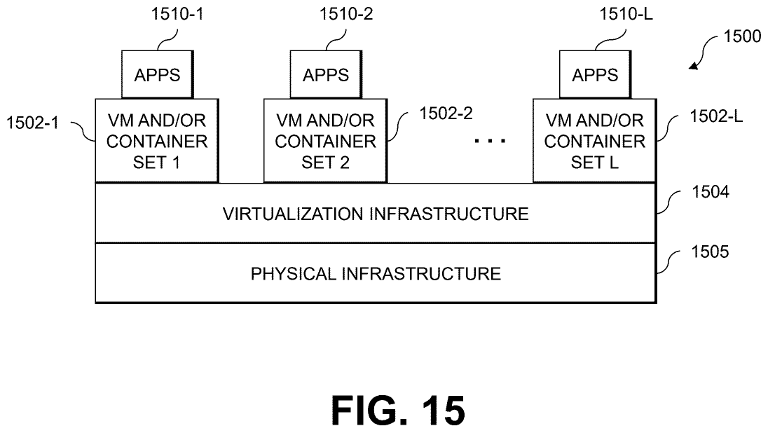

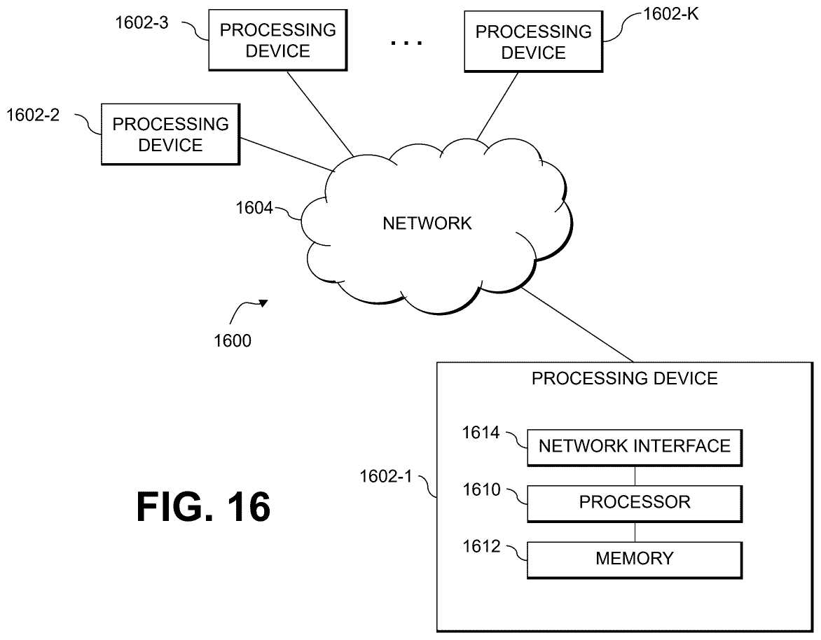

Additional examples of processing platforms utilized to implement the support platform 114 and other components of the information processing system 100 in illustrative embodiments will be described in more detail below in conjunction with FIGS. 15 and 16.

It is to be understood that the particular set of elements shown in FIG. 1 for machine learning-based management of backup operations is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

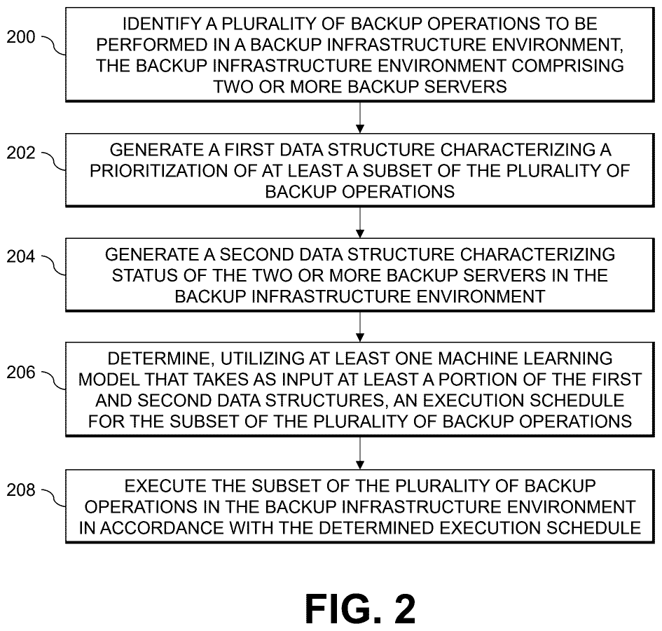

An exemplary process for machine learning-based management of backup operations will now be described in more detail with reference to the flow diagram of FIG. 2. It is to be understood that this particular process is only an example, and that additional or alternative processes for machine learning-based management of backup operations may be used in other embodiments.

In this embodiment, the process includes steps 200 through 208. These steps are assumed to be performed by the support platform 114 utilizing the machine learning-based backup operation management tool 116, the backup environment monitoring logic 118 and the backup operation scheduling logic 120. The process begins with step 200, identifying a plurality of backup operations to be performed in a backup infrastructure environment, the backup infrastructure environment comprising two or more backup servers. The backup infrastructure environment may further comprise backup storage infrastructure, the two or more backup servers being configured to store data to be backed up on the backup storage infrastructure.

In step 202, a first data structure is generated, the first data structure characterizing a prioritization of at least a subset of the plurality of backup operations. Step 202 may comprise, for a given backup operation in the subset of the plurality of backup operations, determining a priority based at least in part on (i) a predicted execution time of the given backup operation and (ii) a waiting time of the given backup operation.

In step 204, a second data structure is generated, the second data structure characterizing status of the two or more backup servers in the backup infrastructure environment.

An execution schedule for the subset of the plurality of backup operations is determined in step 206 utilizing at least one machine learning model that takes as input at least a portion of the first data structure and at least a portion of the second data structure. The at least one machine learning model may comprise a reinforcement learning model. The reinforcement learning model may implement an actor-critic deep reinforcement learning algorithm.

The at least one machine learning model may comprise a multi-agent reinforcement learning model comprising a first agent that takes as input the first data structure and a second agent that takes as input the second data structure. The first agent of the multi-agent reinforcement learning model may operate at first time intervals, and the second agent of the multi-agent reinforcement learning model may operate at second time intervals. A length of each of the second time intervals may be a designated multiple of a length of each of the first time intervals. The first agent of the multi-agent reinforcement learning model may be associated with a first action space, a first state space and a first reward function, and the second agent of the multi-agent reinforcement learning model may be associated with a second action space, a second state space and a second reward function.

A first action space associated with the first agent of the multi-agent reinforcement learning model may characterize whether respective ones of the plurality of backup operations are allocated to one of the two or more backup servers for execution, and a second action space associated with the second agent of the multi-agent reinforcement learning model may characterize whether respective ones of the two or more backup servers in the backup infrastructure environment are active.

A first state space associated with the first agent of the multi-agent reinforcement learning model may characterize execution times for ones of the plurality of backup operations that are allocated to one of the two or more backup servers for execution in the backup infrastructure environment, and a second state space associated with the second agent of the multi-agent reinforcement learning model may characterize a sum of (i) the execution times for ones of the plurality of backup operations that are allocated to one of the two or more backup servers for execution in the backup infrastructure environment and (ii) execution times for ones of the plurality of backup operations that are not allocated to one of the two or more backup servers for execution in the backup infrastructure environment. The first state space may further characterize priorities for ones of the plurality of backup operations that are allocated to one of the two or more backup servers for execution in the backup infrastructure environment, and the second state space may further characterize a number of the plurality of backup operations arriving in a current time slot and a number of the plurality of backup operations not executed in a previous time slot. The first state space may further characterize which of the two or more backup servers are active in a task scheduling time slot, and the second state space may further characterize which of the two or more backup servers are active in a resource optimization time slot, the resource optimization time slot comprising two or more instances of the task scheduling time slot.

A first reward function associated with the first agent of the multi-agent reinforcement learning model may be based at least in part on a first weighted sum of average priority of the plurality of backup operations in a task scheduling time slot and a proportion of the two or more backup servers that are active in the task scheduling time slot, and a second reward function associated with the second agent of the multi-agent reinforcement learning model may be based at least in part on a second weighted sum of average priority of the plurality of backup operations in a resource optimization time slot and a proportion of the two or more backup servers that are active in the resource optimization time slot, the resource optimization time slot comprising two or more instances of the task scheduling time slot.

In step 208, the subset of the plurality of backup operations are executed in the backup infrastructure environment in accordance with the determined execution schedule.

It should be noted that the term “data structure” as used herein is intended to be broadly construed. A data structure, such as any single one of or combination of the first and second data structures referred to above, may provide a portion of a larger data structure, or any one of or combination of the first and second data structures may be combinations of multiple smaller data structures. Therefore, the first and second data structures referred to above may be different parts of a same overall data structure, or one or more of the first and second data structures could be made up of multiple smaller data structures. The data structures may include tables, vectors, embeddings, or various other data structures. In some embodiments, the data structures are specifically formatted or generated such that they are suitable for use as at least one of an input to and an output from a machine learning model.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Data is a valuable asset for any enterprise, organization or other entity. As entities amass increasing volumes of data and store them across an IT infrastructure (e.g., from on-premises data centers to hybrid cloud architectures), keeping that information protected and consistently available is more critical than ever. Data backup is vital for any entity. Backing up data entails making and storing copies of an entity's information. This includes application and product data, customer or other user files, employee and supplier records, competitive research, etc. Data backup may include creating partial or full backups on a variety of storage media, such as hard drives, storage arrays, solid-state or flash drives, etc. Cloud-based storage is becoming an increasingly popular archival destination for entity data backup and database backups.

Backup servers are configured to manage backup operations, and maintain a backup database containing information about the backup configuration, backup metadata, etc. The backup configuration may contain information about when to run backup operations, which client data is to be backed up in different backup operations, etc. The backup metadata includes information about the backed-up data. The role of a backup server is to gather the data that is to be backed up and to send it to backend storage systems (e.g., Dell DataDomain storage systems). Backup clients can be installed on application servers, mobile clients, desktops, etc. The backup clients may send tracking information to the backup servers.

In an organization, different database technology (e.g., Structured Query Language (SQL), non-SQL (NoSQL), Oracle, PostgreSQL, MongoDB, etc.) backups may be configured and managed manually by database administrator (DBA) engineers. Database servers are configured to utilize backup servers (e.g., through backup clients which may run on the database servers or on client devices which control, manage or otherwise access the database servers). Backup operations (also referred to as backup tasks or backup jobs) may fail for a variety of reasons, such as network issues, lack of availability of backup threads, backup server throughput issues, etc. IT monitoring solutions may be flooded with lots of incidents due to backup operation failures, and support engineers (e.g., L1 engineers) are responsible for fixing the issues with the backup operations (e.g., by manually restarting the backup operations, which may be SQL agent jobs, CRON jobs, etc.). Every quarter, backup operation failures may generate thousands (e.g., 3000+) of incidents and consume significant human hours (e.g., 45,000+) by support engineers for remediation.

Illustrative embodiments provide technical solutions for optimizing the scheduling efficiency of backup operations, thus improving resource utilization of backup tasks. In some embodiments, the technical solutions provide a system for machine learning-based management of backup operations (e.g., the machine learning-based backup operation management tool 116 of the support platform 114) which implements a reinforcement deep learning framework that identifies backup operation patterns and evaluates against environment base metrics. Based on the outcome of an algorithm implemented by the reinforcement deep learning framework, the machine learning-based backup operation management tool will assign backup operations to backup servers, and the backup servers will assign the backup operations to available storage resources in backend storage where data backups are stored. This enables more backup operations to succeed and minimizes backup operation failure events. The backup servers are thus enabled to dynamically manage the connections with backend storage servers, and resources are efficiently utilized across all available backend storage servers. The technical solutions also enable self-healing features which minimize the re-running of backup operations. Advantageously, use of the technical solutions can provide significant cost savings (e.g., monetary costs, support engineer manual efforts, etc.).

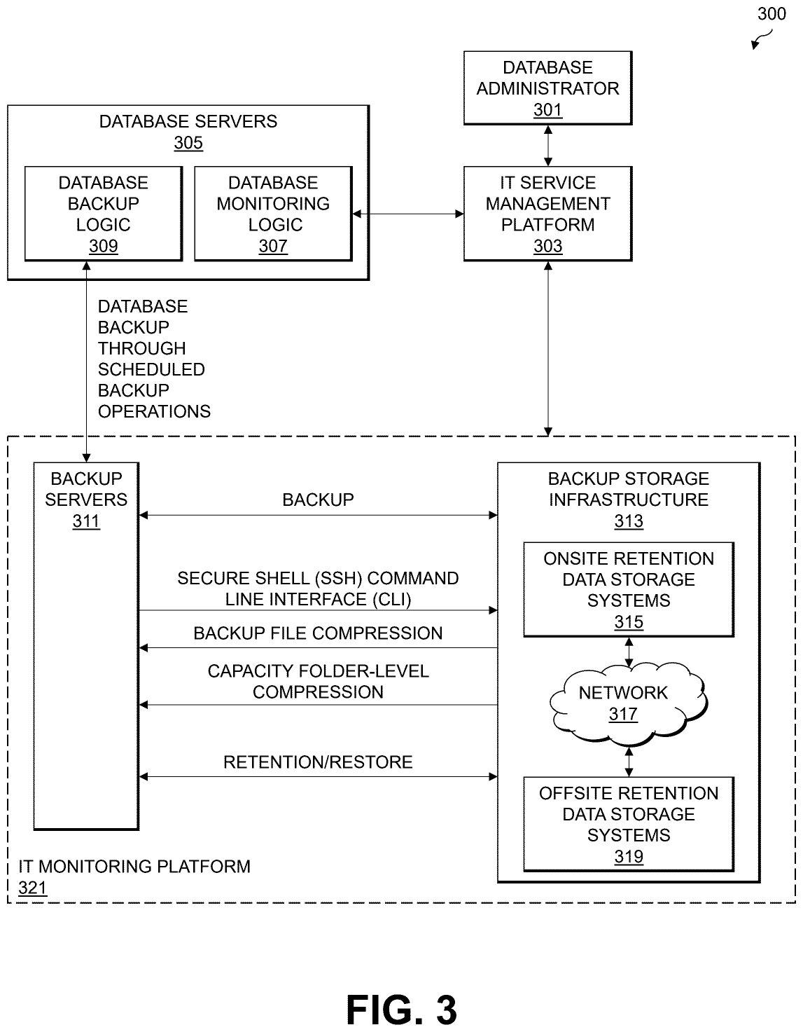

File system and database servers may trigger backup operations, and a network client may assign the backup operations through configured backup servers to backend storage servers. Such an approach is illustrated in FIG. 3, which shows a system 300 including a DBA 301 which utilizes an IT service management platform 303 (e.g., ServiceNow) to access one or more database servers 305. The database servers 305 implement database monitoring logic 307 and database backup logic 309. The database monitoring logic 307 is accessed by the DBA 301 via the IT service management platform 303 to monitor health of the database servers 305. The database backup logic 309 is configured to initiate backup of the database servers 305 (e.g., at least portions of one or more databases maintained by the database servers 305) through scheduled backup operations which are sent to backup servers 311. The backup servers 311 interact with backup storage infrastructure 313 (e.g., Dell DataDomain systems) to perform backup operations as well as retention/restore operations, which in the FIG. 3 example includes onsite retention data storage systems 315 which are connected via a network 317 (e.g., a WAN) to offsite retention data storage systems 319, with replication operations being performed between the onsite retention data storage system 315 and the offsite retention data storage system 319. The backup servers 311 may access the backup storage infrastructure 313 via a Secure Shell (SSH) Command Line Interface (CLI) to obtain information related to backup file compression, capacity folder-level compression, etc. The backup servers 311 and the backup storage infrastructure 313 may be part of or connected to an IT monitoring platform 321 (e.g., Zabbix, System Center Operations Manager (SCOM), etc.). Due to overload of the backup storage infrastructure 313, in some cases new connections get queued for a longer time. This can lead to performance issues for the backup servers 311 and/or the backup storage infrastructure 313, and can also lead to backup operations being terminated or otherwise failing. This results in more incident alerts that support engineers must manage.

In the system 300, backup processing starts with trigger of backup operations scheduled in the database servers 305 (or other database technologies) through backup agents or native crontab jobs (e.g., implemented via the database backup logic 309). Each of the database servers 305 are added as clients in the backup servers 311, which maintain backup metadata and store backups in the backup storage infrastructure 313. Execution of the backup operations, and health of the backup servers 311 and the backup storage infrastructure 313, may be monitored utilizing the IT monitoring platform 321, which generates incidents that are provided to the IT service management platform 303. The DBA 301 or other database engineers providing support for the database servers 305 will act on the incidents for backup operation failures (e.g., by re-triggering the backup operations, engaging backup engineers to fix the issues with the backup servers 311 and/or backup storage infrastructure 313 which caused the backup operation failures, etc.).

In some embodiments, the technical solutions are configured to collect real-time metrics related to the backup servers 311 and the backup storage infrastructure 313, and analyze past patterns of the backup operations against the backup servers 311. The technical solutions utilize one or more machine learning algorithms to intelligently decide and assign backup operations to the next resources available in the backup servers 311 and the backup storage infrastructure 313. The machine learning algorithms may include a reinforcement deep learning framework, which obtains data feeds (e.g., of backup operation triggers) from the database servers 305 along with real-time metrics related to the backup servers 311 and/or the backup storage infrastructure 313 (e.g., CPU, memory, available resource processing threads, etc.). The reinforcement deep learning framework may also utilize configuration management database (CMDB) details to decide on the available data storage server (e.g., onsite retention data storage systems 315 and offsite retention data storage systems 319 in the backup storage infrastructure 313) which the backup servers 311 should utilize for different backup operations with dynamic intelligence. The reinforcement deep learning framework may implement reinforcement learning algorithms and deep neural network (DNN) processes to help identify patterns and identify any anomalies (e.g., from file activity, change rates, etc.) alerting of potential threats or issues that may occur.

Backup operations (e.g., received from applications or clients for backing up databases, file systems, etc.) may result in failures. On analyzing the trend of such failures, the causes of such failures include configuration issues, overload on backup servers, congestion of backup operations, etc. When a backup server is reaching a maximum threshold of backup operation sessions as well as resource usage, the backup server gets hung and does not accept new sessions, which may also result in termination of backup operation sessions.

Backup of databases for different database technologies across a large IT infrastructure ecosystem is complex and dynamically changing. To achieve efficient and effective scheduling, heuristic algorithms rely on precise environment modeling. If the environment cannot be accurately modeled, a reasonable and effective scheduling algorithm will not be successfully applied. Therefore, conventional approaches for database backup scheduling utilize basic and simple algorithms (e.g., a First Come First Serve (FCFS) algorithm) as it is too hard to model the environment precisely due to the uncertainty of the coming tasks and the dynamic IT infrastructure environment. For example, the execution time of a task (e.g., a backup operation) is affected by network bandwidth, size of databases, processing performance of different machines, available threads, location of the required resources to support the task execution, etc.

Database backup scheduling is usually performed without any prior experience and prepared information support. There are no patterns available to predict the arrival of backup operations, and further the number and size of database backup operations which are coming next are unknown. Thus, conventional approaches must schedule backup operations without any prior experience or prepared information.

Resource requirements for backup operation execution change dynamically. For database backup operations, the demand for resources varies according to different time periods, environmental conditions, etc. Most of the time, schedules are manually adjusted or additional hardware is configured to meet the resources demand. There is thus a need for scheduling algorithms to automatically optimize resource utilization based on changing demand.

Illustrative embodiments provide technical solutions for leveraging machine learning (e.g., deep reinforcement learning) to optimize or improve scheduling efficiency and to improve resource utilization for backup operations. This is a multiple-objective optimization problem, which addresses the demand for backup operation scheduling of database or other backup operations. Management of database or other backup operations in large scale IT infrastructure environments often manifests as difficult administrative tasks where appropriate solutions depend on understanding the workload of backup servers 311, backup storage infrastructure 313 and database environments (e.g., database servers 305).

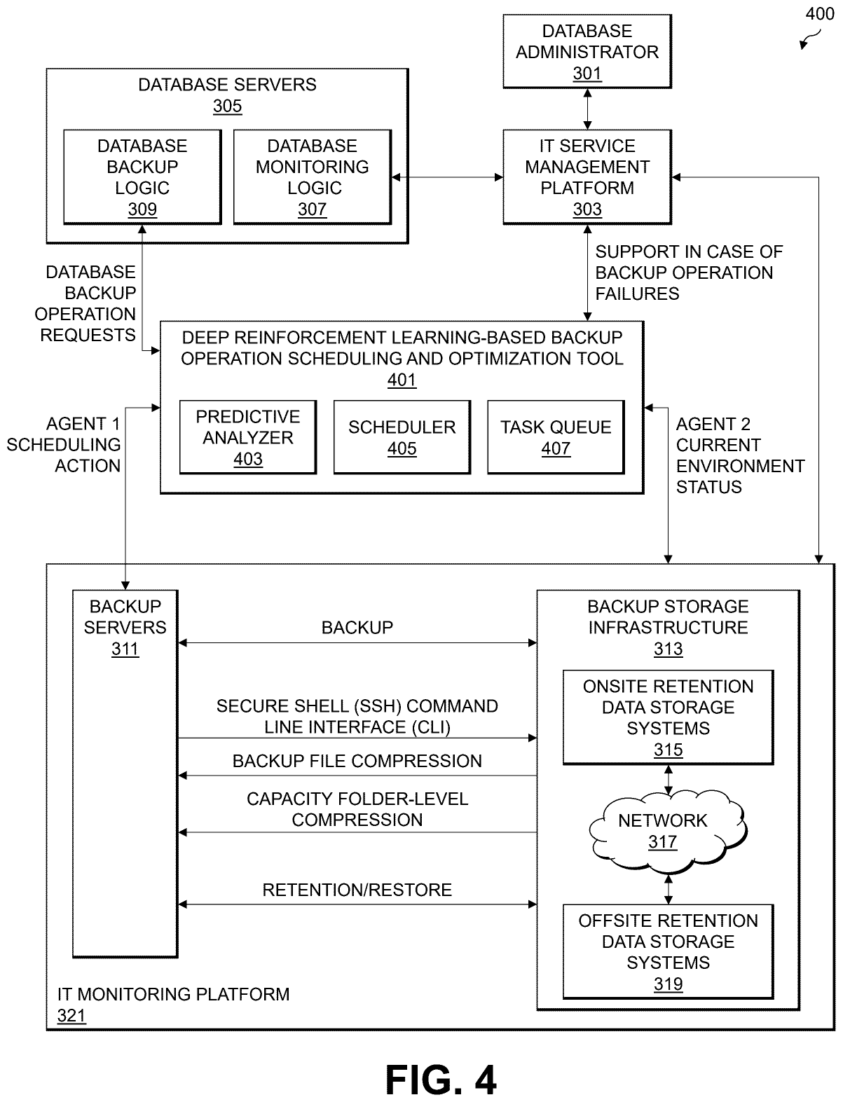

FIG. 4 shows a system 400 which includes a deep reinforcement learning-based backup operation scheduling and optimization tool 401 implementing a predictive analyzer 403, a scheduler 405, and a task queue 407 (e.g., of backup operations to be performed). The deep reinforcement learning-based backup operation scheduling and optimization tool 401 receives, from the database backup logic 309 of the database servers 305, database backup operation requests. The deep reinforcement learning-based backup operation scheduling and optimization tool 401 implements multiple agents of a reinforcement learning framework, including a first agent (Agent 1) that performs scheduling actions (e.g., providing database backup operation requests to the backup servers 311) and a second agent (Agent 2) that monitors current environment status (e.g., from the IT monitoring platform 321 and/or directly from the backup servers 311 and/or the backup storage infrastructure 313). The deep reinforcement learning-based backup operation scheduling and optimization tool 401 also communicates with the IT service management platform 303 to provide support in the case of backup operation failures. It should be noted that, although shown as a separate entity (e.g., running on a distinct server or other processing platform), the deep reinforcement learning-based backup operation scheduling and optimization tool 401 may be implemented at least in part internal to one or more other components of the system 400, such as the IT service management platform 303, the database servers 305, the backup servers 311, the backup storage infrastructure 313 and/or the IT monitoring platform 321.

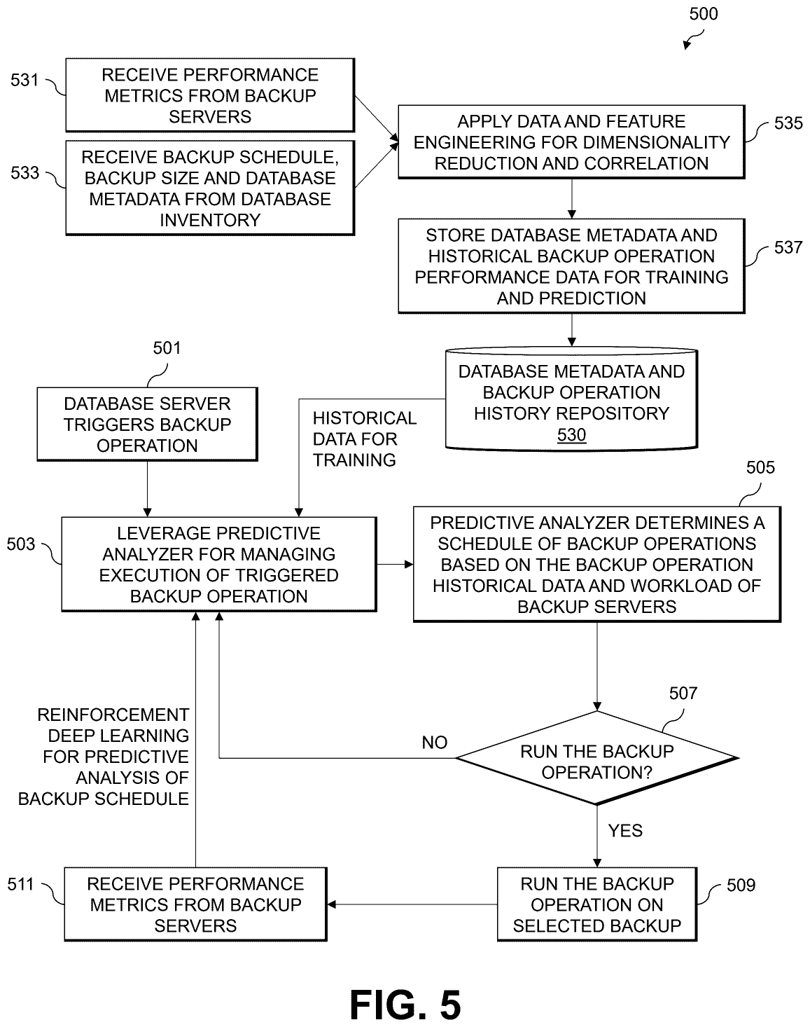

FIG. 5 shows a process flow 500 which may be performed in the system 400 utilizing the deep reinforcement learning-based backup operation scheduling and optimization tool 401. The process flow 500 begins in block 501 when a backup operation is triggered (e.g., by one of the database servers 305). In block 503, the predictive analyzer 403 is leveraged for managing execution of the backup operation triggered in block 501. To do so, the predictive analyzer 403 in block 503 takes in historical data for training of a reinforcement deep learning framework. The historical data is obtained from a database metadata and backup operation history repository 530. In block 531, performance metrics from the backup servers 311 is received. In block 533, a backup schedule, backup size and database metadata are received from database inventory (e.g., which may be maintained or determined from information obtained by the backup servers 311 and/or the database servers 305). In block 535, feature engineering for dimensionality reduction and correlation is applied to the information received in blocks 531 and 533. Blocks 531 and 533 may be run as part of batch processes. In block 537, database metadata and historical backup operation performance data is stored in the database metadata and backup operation history repository 530 for training of a reinforcement deep learning framework and performing predictions utilizing the trained reinforcement deep learning framework.

In block 505, the predictive analyzer 403 is used to determine a schedule of backup operations (e.g., including the backup operation triggered in block 501 and other backup operations in the task queue 407) based on the backup operation historical data and the workload of the backup servers 311. For example, the predictive analyzer 403 may correlate a database size along with CPU, memory or other metrics to predict run time of backup operations and optimize the scheduling of the backup operations against backup servers 311 and the backup storage infrastructure 313 (e.g., different backend storage resources thereof, such as different backend storage servers which are part of the onsite retention data storage systems 315 and/or the offsite retention data storage systems 319). Whenever run time of backup operations increases the number of threads running on a particular one of the backup servers 311 and/or backend storage resources of the backup storage infrastructure 313 beyond some defined threshold number of threads or when resource usage (e.g., CPU, memory, network, etc.) in a particular one of the backup servers 311 and/or backend storage resource of the backup storage infrastructure 313 crosses some defined resource threshold, the scheduler 405 will skip the current one of the backup servers 311 and/or backend storage resources in the backup storage infrastructure 313 and work on the next available one of the backup servers 311 and/or backend storage resources in the backup storage infrastructure 313 for the execution of backup operations.

In block 507, a determination is made as to whether to run the backup operation triggered in block 501. If the result of the block 507 determination is no, the process flow 500 returns to block 503. If the result of the block 507 determination is yes, the process flow 500 proceeds with running the backup operation (triggered in block 501) on a selected one of the backup servers 311 and/or backend storage resources in the backup storage infrastructure 313 in block 509. In block 511, performance metrics are received from the backup servers 311 and/or the backend storage resources in the backup storage infrastructure 313 (e.g., while the backup operations are running), which is used for reinforcement deep learning and the predictive analysis of the backup schedule.

The deep reinforcement learning-based backup operation scheduling and optimization tool 401 may be used to build a database backup management system that learns to manage a backup operation schedule directly from experience. This includes predicting the execution of backup operations against targeted ones of the backup servers 311 and/or the backend storage resources in the backup storage infrastructure 313 based on the current workload and backup run time. The current workload information may be derived from available metrics (e.g., CPU, memory, IO, network, etc.). Backup run time may be derived based on database size, historical data, etc.

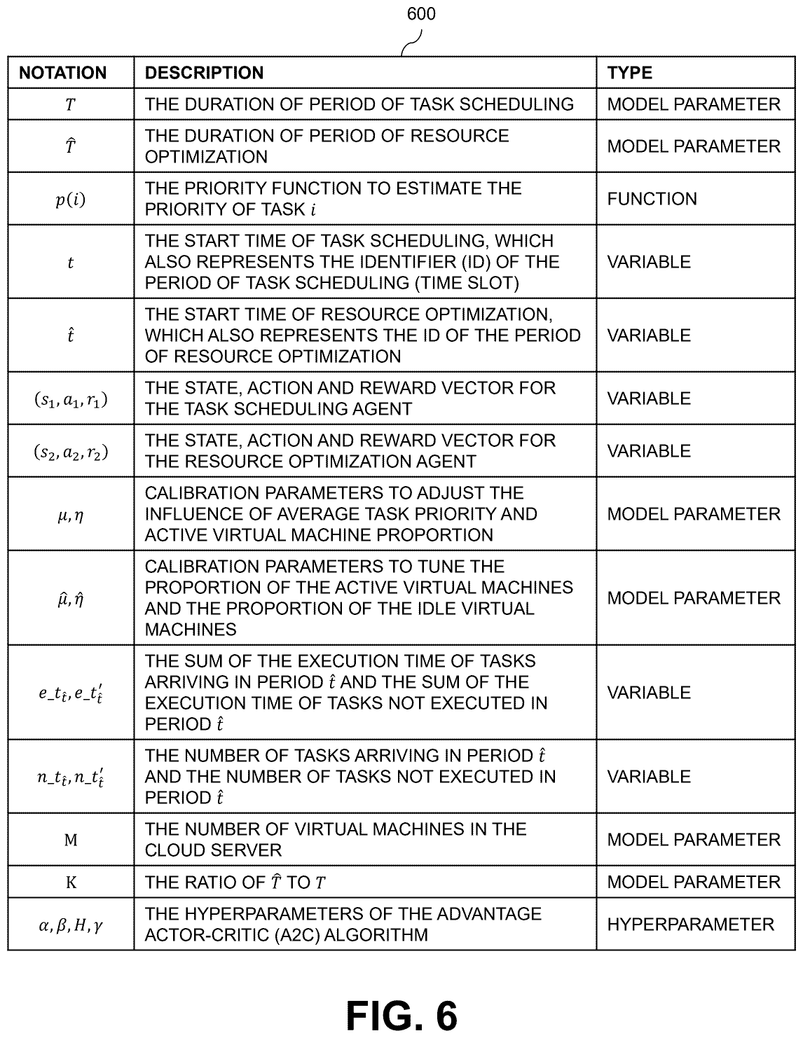

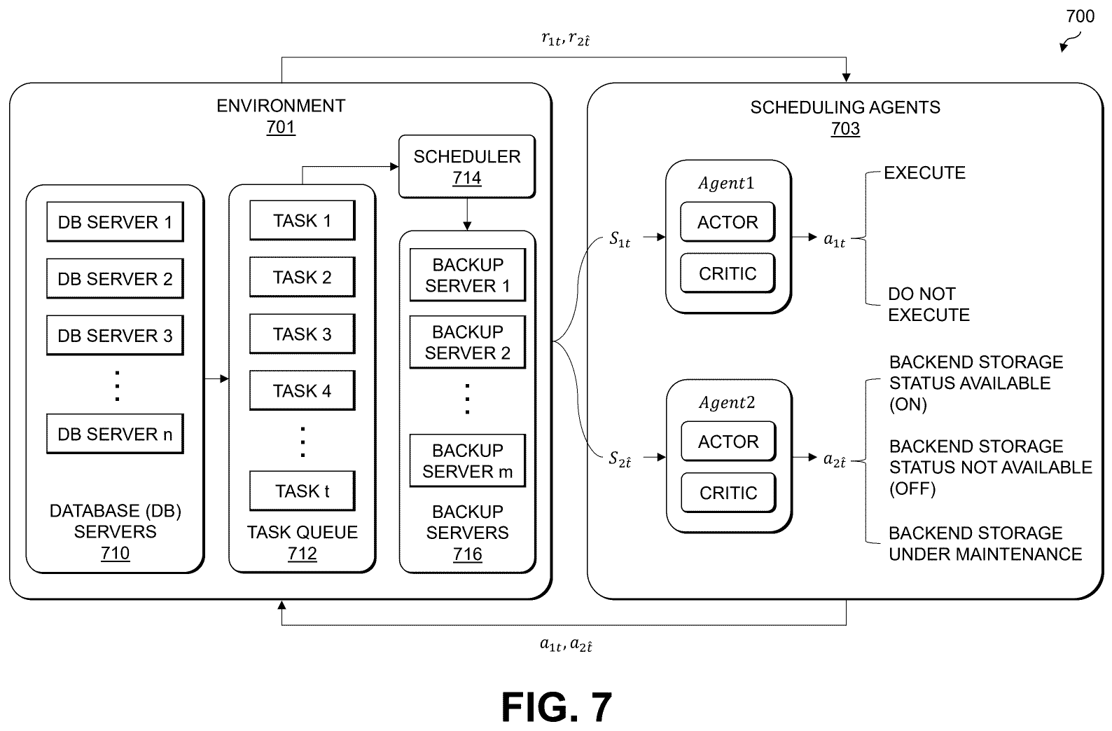

A deep reinforcement learning-based backup operation scheduling model (e.g., which may be implemented by the predictive analyzer 403 of the deep reinforcement learning-based backup operation scheduling and optimization tool 401) will now be described. FIG. 6 shows a table 600 of notations (and their corresponding description and type) which are used by the deep reinforcement learning-based backup operation scheduling model. The deep reinforcement learning-based backup operation scheduling model may utilize an architecture 700 as shown in FIG. 7, which includes an environment 701 and scheduling agents 703. The environment 701 includes a set of database servers 710 (DB servers 1, 2, 3, . . . , n), a task queue 712 (tasks 1, 2, 3, 4, . . . , t), a scheduler 714, and backup servers 716 (backup servers 1, 2, . . . , m). The task queue 712 has a pool of unimplemented tasks (e.g., backup operations) in the backup servers 716. The backup servers 716 represent the container for storing database or other data backups. The scheduler 714 is a dispatcher for executing tasks (e.g., backup operations) from the task queue 712 as directed by the scheduling agents 703. In the architecture 700 shown in FIG. 7, it is assumed that the number of backup servers 716 is fixed, and that the configuration and performance of all of the backup servers 716 are the same. Tasks (e.g., backup operations) in the task queue 712 can be scheduled on the backup servers 716 based on any idle backup data domains. The backup servers 716 are denoted as BSs=bs₁, bs₂, bs₃, . . . , bsₘ, where bsᵢ is the handle of backup server i. The scheduling agents 703 include two scheduling agents: Agent1 and Agent2. Agent1 is responsible for backup operation task scheduling, and Agent2 is responsible for monitoring resource utilization (e.g., CPU, memory, IO, data domain resources, etc.).

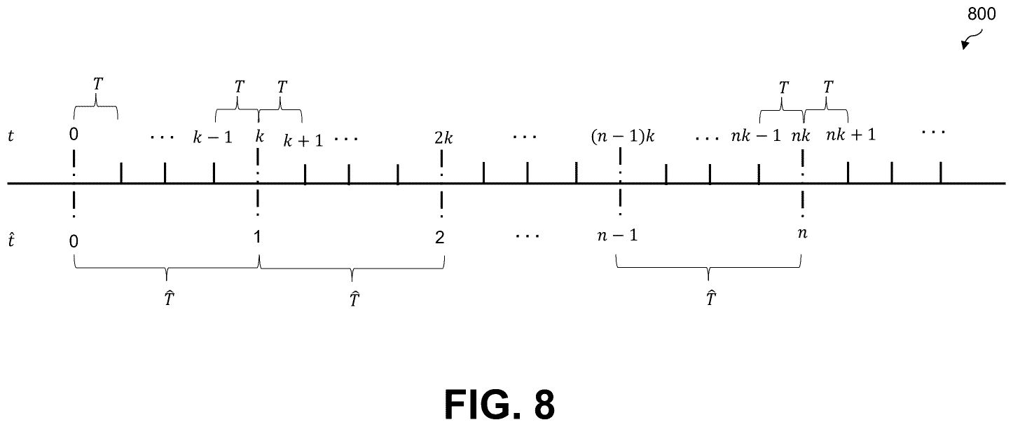

In the deep reinforcement learning-based backup operation scheduling model, time is an important factor in task scheduling and optimization of resource utilization. The time in the deep reinforcement learning-based backup operation scheduling model is divided into two types, time t and \hat{t}, as shown in the model 800 of scheduling time in FIG. 8. t is the start time of task scheduling, and \hat{t} is the start time of optimization of resource utilization. Times t and \hat{t} are defined in relative time periods for ease of calculation. The initial value of t and \hat{t} is 0. In the deep reinforcement learning-based backup operation scheduling model, each task scheduling lasts T seconds and each optimization of resource utilization lasts \hat{T} seconds, where \hat{T} is greater than T. \hat{T}=K*T, where K>0 and K is a parameter in the deep reinforcement learning-based backup operation scheduling model configuration which indicates that the optimization of resource utilization spends more time than task scheduling. Here, the interval between t and t+1 is defined as time slot t, so T is the duration of time slot t. The same definition is used for time slot \hat{t}.

At time t, Agent1 makes the decision on whether to execute each task (e.g., backup operation) in the task queue 712. The scheduling action decision is stored as a₁ₜ. After \hat{T} seconds, that is, at time \hat{t}, the system started to optimize resource utilization. The backup server would turn on or off backup operation processing according to the optimization decision action @2f output by Agent2. This procedure will now be described in further detail.

Whenever time t comes, the deep reinforcement learning-based backup operation scheduling model receives tasks (e.g., backup operations) arriving from the time t and stores the tasks in the task queue 712. Then, the following actions are performed in sequence:
(i) The deep reinforcement learning-based backup operation scheduling model selects tasks according to a priority calculated by p(i), which is the task priority function defined below, and the current state of the environment, Sit, is input to Agent1.
(ii) Agent1 outputs action alt and returns it to the environment 701.
(iii) The environment 701 executes alt, and returns reward r₁ₜ to Agent1 when a₁ₜ is finished.
   When all tasks in the task queue 712 are arranged to execute according to alt, the deep reinforcement learning-based backup operation scheduling model enters the next task scheduling time slot t+1.

Whenever time \hat{t} is reached, the deep reinforcement learning-based backup operation scheduling model starts the optimization of resource utilization. At time \hat{t}, the following actions are performed in sequence:
(i) The current environment status s_{2\hat{t}} is input to Agent2.
(ii) Agent2 outputs action decision a_{2\hat{t}} and returns it to the environment 701.
(iii) The environment 701 executes a_{2\hat{t}} to stop or start certain ones of the backup servers 716, and returns reward r_{2\hat{t}} to Agent2. The deep reinforcement learning-based backup operation scheduling model then enters the next resource utilization optimization time slot \hat{t}+1.

Tasks are the backup operations running on the backup servers 716. Tasks arriving in time slot t are added to the task queue 712 for backup allocation. The environment 701 has little or no information about the exact number and size of the tasks in advance. In some embodiments, the task priority function p(i) is used to estimate the priority of task i:

$$p ( i ) = \frac{( {e}_{i} + {w}_{i} )}{{e}_{i}}$$

where eᵢ is the execution time of task i, and wᵢ is the waiting time of task i. After the priorities are calculated, tasks are scheduled according to their priorities.

Action1 is the action space of all actions in task scheduling. The elements of Action1, a₁ᵢ, indicate whether a certain backup server was allocated to the task i, where a₁ᵢ∈[0,1]. The values of a₁ᵢ are determined according to the following equation:

$${a}_{1 i} = \{ \begin{matrix}1 , & if task i gets assigned to a backup server \\ 0 , & if task i is not assigned to a backup server\end{matrix}$$

State1 is the state space of Agent1 for task scheduling in the environment 701. Sit, an instance of State1, is defined as the vector (e₁ₜ, pₜ, m₁ₜ, n₁ₜ), where e₁ₜ is the execution time of the task that was allocated to a backup server, pₜ is the priority of the task that was allocated to a backup server, m₁ₜ is the average priority of all tasks in the task queue 712, and n₁ₜ is the proportion of the active backup data domain in the backup servers, and Nt is the number of tasks in time slot t:

$$\begin{matrix}{m}_{1 t} = \frac{1}{N t} {\sum }_{i = 1}^{Nt} p ( i ) \\ {n}_{1 t} = \frac{{n}_{active - b s}}{M}\end{matrix}$$

Reward1 is the reward value representing the feedback after the Action1 was performed. The reward value of time slot t is defined according to the following equation:

$${r}_{1 t} = μ * {m}_{1 t} + η * {n}_{1 t}$$

where μ and η are calibration parameters used to adjust the influence of the average task priority m₁ₜ and the active backup data domain proportion n₁ₜ. The values of μ and η may be between −1 and 1.

Action2 represents the number of backup data domains available (e.g., on or off) in time slot t. An instance of Action2 is defined as a_{2\hat{t}}∈[−M, M]. When a_{2\hat{t}} is greater than 0, it means that there is a backup server data domain available. When a_{2\hat{t}} is equal to 0, it means that there is no backup server data domain available. When a_{2\hat{t}} is less than 0, it means that the backup server data domain has issues or is under maintenance.

State2 is the state space for Agent2. s_{2\hat{t}} is an instance of State2, defined as (e_{2\hat{t}}, l_{\hat{t}}, m_{2\hat{t}}, n_{2\hat{t}}), where e_{2\hat{t}} is defined as the logarithm of the sum of e_t_{\hat{t}} and e_t_{\hat{t}-1}, where e_t_{\hat{t}} is the sum of the task execution times of the tasks arriving in time slot \hat{t}, and e_t_{\hat{t}-1} is the sum of the task execution times of the tasks arriving in the previous time slot \hat{t}−1. l_{\hat{t}} is the logarithm of the sum of n_t_{\hat{t}} and n_t_{\hat{t}-1}, where n_t_{\hat{t}} is the number of the tasks arriving in time slot \hat{t}, and n_t_{\hat{t}-1} is the number of tasks not executed in the previous time slot \hat{t}−1. m_{2\hat{t}} is the average value of m₁ₜ in time slot \hat{t}. n_{2\hat{t}} is the average proportion of idle backup data domain in time slot t.

$$\begin{matrix}\begin{matrix}{e}_{2 \hat{t}} = log ( {e\_t}_{\hat{t}} + {e\_t}_{\hat{t} - 1} ) , & \hat{t} = 0 , 1 , 2 , 3 , …\end{matrix} \\ \begin{matrix}{l}_{2 \hat{t}} = log ( {n\_t}_{\hat{t}} + {n\_t}_{\hat{t} - 1} ) , & \hat{t} = 0 , 1 , 2 , 3 , …\end{matrix} \\ \begin{matrix}{m}_{2 \hat{t}} = \frac{1}{K} {\sum }_{i = K * ( \hat{t} - 1 )}^{K * \hat{t}} {m}_{1 i} , & \hat{t} = 0 , 1 , 2 , 3 , … ; K = \frac{\hat{T}}{T}\end{matrix} \\ \begin{matrix}{n}_{2 \hat{t}} = \frac{1}{K} {\sum }_{i = K * ( \hat{t} - 1 )}^{K * \hat{t}} {n}_{1 i} , & \hat{t} = 0 , 1 , 2 , 3 , … ; K = \frac{\hat{T}}{T}\end{matrix}\end{matrix}$$

Reward2 is the value of the reward function for Agent2, and is determined according to the following equation:

$${r}_{2 \hat{t}} = \hat{μ} {n}_{2 \hat{t}} - \hat{η} {m}_{2 \hat{t}}$$

where \hat{μ} and \hat{η} are calibration parameters. The value of the calibration parameters may be adjusted according to the actual situation to tune the proportion of the active backup server data domain and the proportion of the idle backup data domain in time slot t.

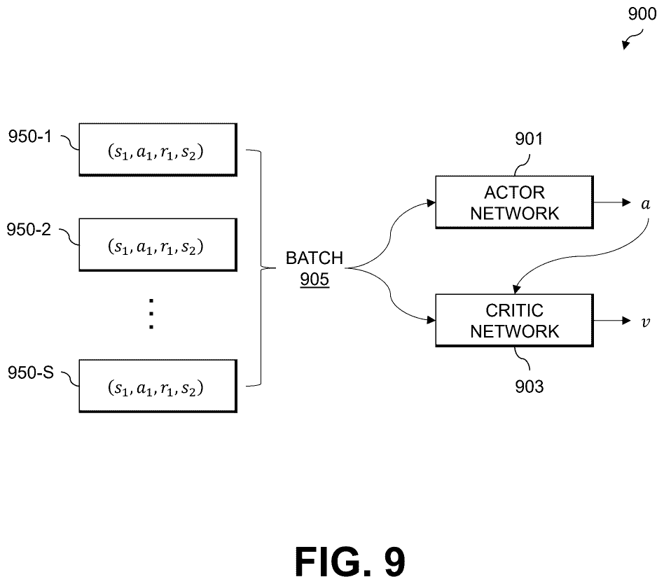

The deep reinforcement learning-based backup operation scheduling model may implement an actor-critic (A2C) deep reinforcement learning algorithm to create the model for scheduling optimization of backup operations. The actor-critic (A2C) algorithm is a hybrid algorithm based on Q-learning and policy gradient, which are two algorithms of reinforcement learning. The A2C algorithm provides outstanding performance in complicated machine learning tasks. FIG. 9 shows an architecture 900 of the A2C algorithm, which includes an actor network 901 used for action selection and a critic network 903 used to evaluate the actions. The actor network 901 and critic network 903 operate on a batch 905 of states, actions and rewards 950-1, 950-2, . . . 950-S.

As described above, Agent1 acts as the optimization model for backup operation scheduling, and Agent2 acts as the optimization model for resource utilization. (State1, Action1, Reward1) and (State2, Action2, Reward2) are used to describe the state space, action space and reward functions of Agent1 and Agent2, respectively. Hence, (s₁ₜ, a₁ₜ, r₁ₜ) and (s_{2\hat{t}}, a_{2\hat{t}}, r_{2\hat{t}}) separately represent one instance in the state spaces, action spaces and reward functions of Agent1 and Agent2 at time slot t and time slot \hat{t}, respectively. The data entry (sₜ, aₜ, rₜ, sₜ₊₁) is recorded as a sample for training with the A2C algorithm. The parameter of the actor network 901 is updated by advantage function A(sₜ, aₜ), and θₐ and θ_{c} are parameters of the actor network 901 and the critic network 903, respectively:

$$\begin{matrix}A ( {s}_{t} , {a}_{t} ) = {r}_{t} + γ {V}^{{π}_{θ}} ( {s}_{t + 1} ; {θ}_{a} ) - {V}^{{π}_{θ}} ( {s}_{t + 1} ; {θ}_{c} ) \\ {θ}_{a} ← {θ}_{a} + α {\sum }_{t} ∇ log {π}_{{θ}_{a}} ( {s}_{t} , {a}_{t} ) A ( {s}_{t} , {a}_{t} ) + β {∇}_{{θ}_{a}} H ( {π}_{θ} ( \cdot \vert {s}_{t} ) ) \\ {θ}_{c} ← {θ}_{c} + {α}^{′} {\sum }_{t} {∇}_{{θ}_{c}} {( A ( {s}_{t} , {a}_{t} ) )}^{2}\end{matrix}$$

where α is the learning rate of the actor network 901, α′ is the learning rate of the critic network 903, β is a hyperparameter, and H is the entropy of the policy.

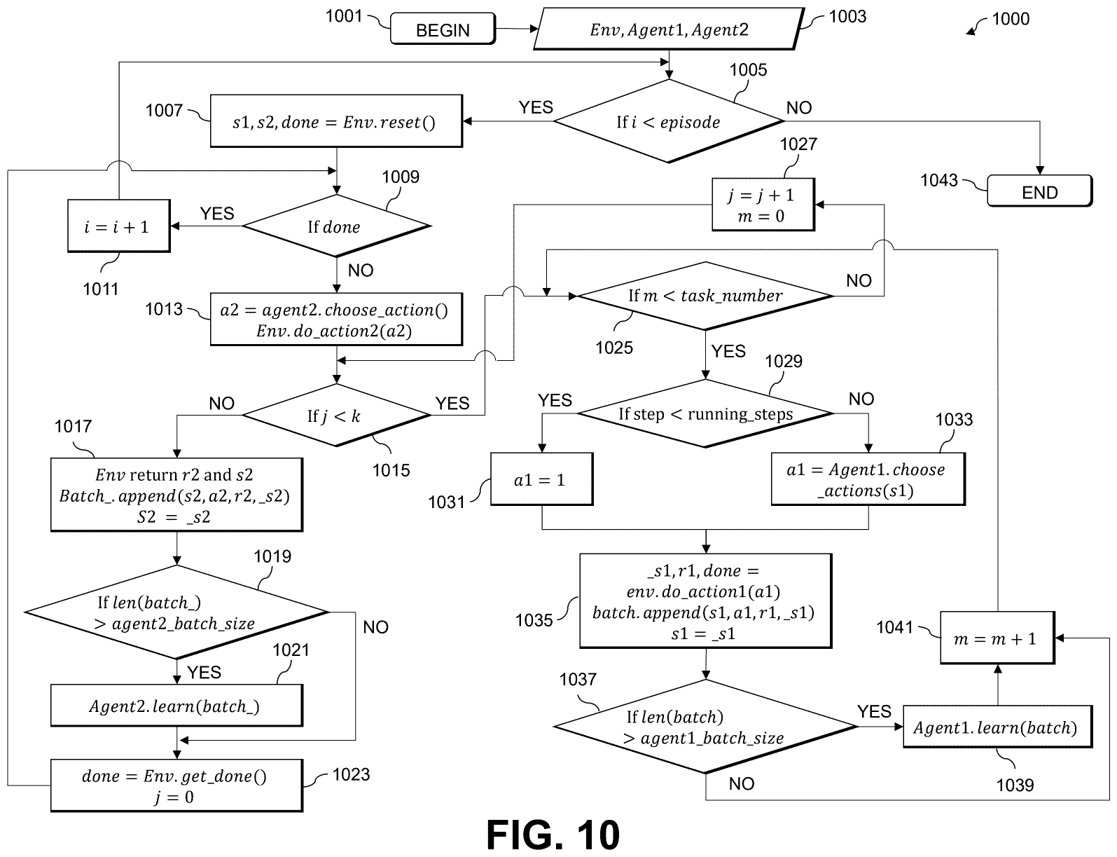

FIG. 10 shows a process flow 1000 for the training algorithm, where running_steps, agent1_batch_size and agent2_batch_size are the control parameters of the training algorithm. The process flow 1000 begins in block 1001, and the environment (Env), Agent1 and Agent2 are initialized in block 1003. In block 1005, a determination is made as to whether i is less than an iteration threshold denoted episode. If the result of the block 1005 determination is no, the process flow 1000 ends in block 1043. If the result of the block 1005 determination is yes, the process flow 1000 proceeds to block 1007 where s1, s2 and a parameter done are used to reset the environment (env.reset( )). In block 1009, a determination is made as to whether all tasks are completed (e.g., according to the parameter done). If the result of the block 1009 determination is yes, the process flow 1000 proceeds to block 1011 where i is incremented (i=i+1) and the process flow 1000 returns to block 1005. If the result of the block 1009 determination is no, then a2 is selected in block 1013 (a2=agent2.choose_action( )) and the environment performs the selected action (Env.do_action2(a2)). The process flow 1000 then proceeds to block 1015, where a determination is made as to whether j<k. If the result of the block 1015 determination is no, the process flow 1000 proceeds to block 1017 where the environment returns the reward value and new state, and appends such information to the batch (Env return r2 and s2, Batch_.append(s2, a2, r2, _s2), S2=_s2). In block 1019, a determination is made as to whether the length of the batch is greater than agent2_batch_size. If the result of the block 1019 determination is yes, the process flow 1000 proceeds to block 1021 where Agent2 performs learning on the batch (Agent2.learn(batch_)). The parameters done and j are then set in block 1023, and the process flow 1000 returns to block 1009. If the result of the block 1015 determination is yes, the process flow 1000 proceeds to block 1025 where a determination is made as to whether m is less than a designated threshold task_number. If the result of the block 1025 determination is no, the process flow 1000 proceeds to block 1027 where j is incremented and m is set to 0. If the result of the block 1025 determination is yes, the process flow 1000 proceeds to block 1029 where a determination is made as to whether the current step is less than a designated threshold running_steps. If the result of the block 1029 determination is yes, then a1 is set to 1 in block 1031. If the result of the block 1029 determination is no, then a1 is selected according to s1 (a1=Agent1.choose_actions(s1)) in block 1033. Following blocks 1031 and 1033, the environment performs the selected action a1, and the batch and s1 are updated in block 1035 (_s1, r1, done=env.do_action1(a1), batch.append(s1, a1, r1,_s1), s1=_s1). In block 1037, a determination is made as to whether the length of the batch is greater than agent1_batch_size. If the result of the block 1037 determination is yes, the process flow 1000 proceeds to block 1039 where Agent1 performs learning on the batch (Agent1.learn(batch)). Following block 1039, or if the result of the block 1037 determination is no, the process flow 1000 proceeds to block 1041 where m is incremented. Following block 1041, the process flow 1000 returns to block 1025.

Floating-point operations per second (FLOPS) is used to evaluate the complexity of the deep reinforcement learning-based backup operation scheduling model. According to the structure of the full-connection network and the input data, the complexity is evaluated by:

$$Time ∼ O ( L * {I}^{2} * K * N )$$

where K is the ratio of duration of resource utilization \hat{T} to the duration of task scheduling T defined in the model of scheduling time, N is the maximum number of tasks in time slot t, I is the number of nodes in the hidden layer, and L is the number of hidden layers of the network of Agent1 and Agent2. Given the A2C-based model, the performance of the deep reinforcement learning-based backup operation scheduling model is highly influenced by K and N. The complexity of the deep reinforcement learning-based backup operation scheduling model trained as described above is about O(6*2²⁰*K*N).

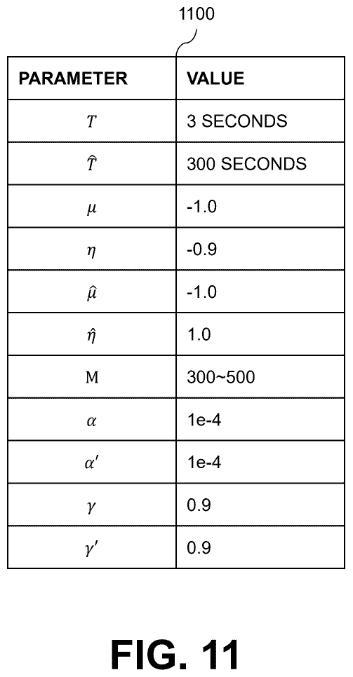

To verify the effectiveness of the deep reinforcement learning-based backup operation scheduling model in a production environment, a trace of data about the backup servers, the backup storage infrastructure (e.g., data domains) and backup operation schedules from a production environment is obtained, which helps to get a better understanding of the characteristics of the backup servers and workloads. This trace data set includes database environment, database backup operations, and data domain resource utilization of about 1300 database servers in a period of 12 hours. The trace data set contains various information, including task or backup operation job identifiers, start time, end time, etc. FIG. 11 shows a table 1100 of parameter values used in the experiment. T and \hat{T} are set to the empirical value in scheduling. M is the number of backup servers in different configurations. α, α′, γ and γ′ are set to the empirical values in the A2C algorithm. μ and η are used to control the average priority of tasks and the proportion of active backup data domains. The default values for them are −1. If the goal is to reduce the priority, the ratio μ/η is increased appropriately. If the goal is to control the cost and reduce the proportion of backup servers, the ratio of μ/η is decreased. The setting of μ′ and η′ is the same.

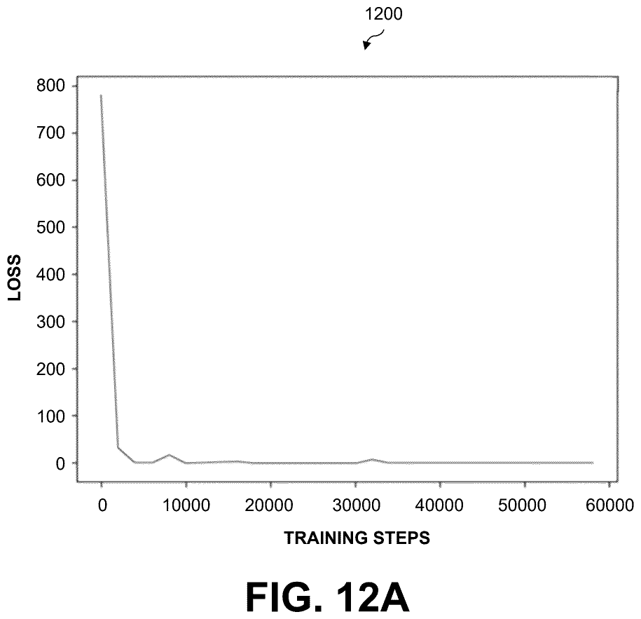

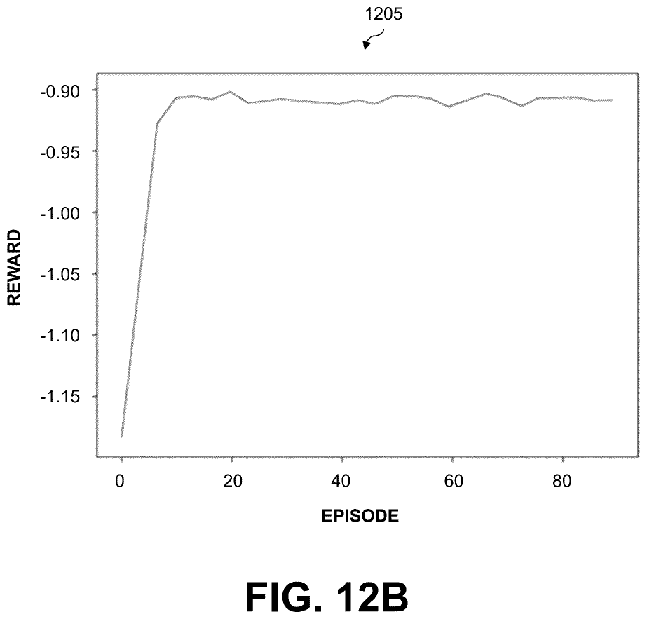

With the trace data from the production environment, the deep reinforcement learning-based backup operation scheduling model is trained with the algorithm introduced above (e.g., the process flow 1000 of FIG. 10), and the loss value is recorded at each training step. The reward values are represented by the average reward of each episode. FIG. 12A shows a loss trend graph 1200, in which the x-axis is the number of training steps and the y-axis is the value of loss. The loss trend graph 1200 shows that, with increase in the number of training steps, the loss gradually decreases until convergence. FIG. 12B shows a reward trend graph 1205, in which the x-axis is the episode and the y-axis is the reward value. The reward trend graph 1205 shows that, with the increase in the number of episodes, the reward gradually increases and eventually converges at a higher value. The loss trend graph 1200 and the reward trend graph 1205 show that the performance of the trained deep reinforcement learning-based backup operation scheduling model is satisfactory.

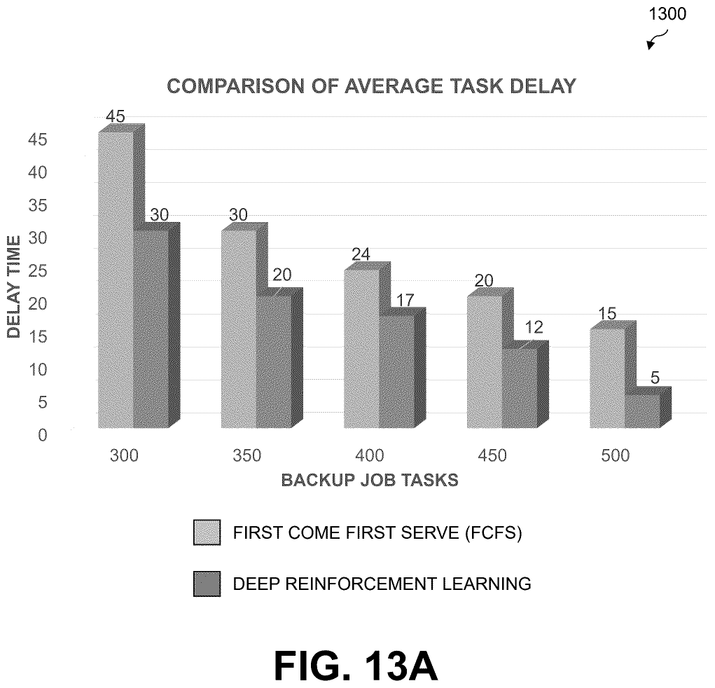

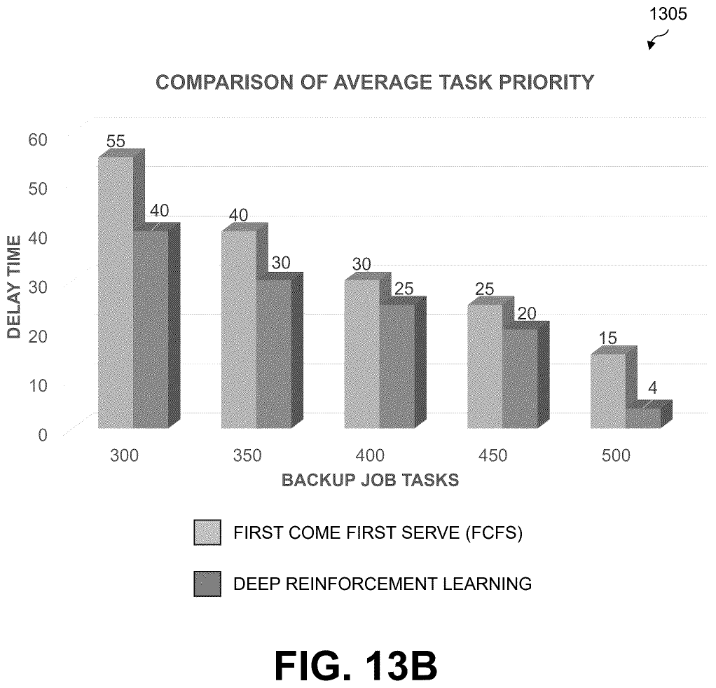

The trained deep reinforcement learning-based backup operation scheduling model is also compared with a conventional FCFS scheduling algorithm. Considering a fixed number of database backup operation tasks 300, 350, 400, 450 and 500 in the backup servers, the trained deep reinforcement learning-based backup operation scheduling model is run on the data set. For this experiment, only the task scheduling agent (Agent1) is considered. The results show the average task delay time (illustrated in plot 1300 of FIG. 13A) and the average task priority (illustrated in plot 1305 of FIG. 13B) of the A2C algorithm used in some embodiments. The results indicate that the trained deep reinforcement learning-based backup operation scheduling model works better in task scheduling than the conventional FCFS approach.

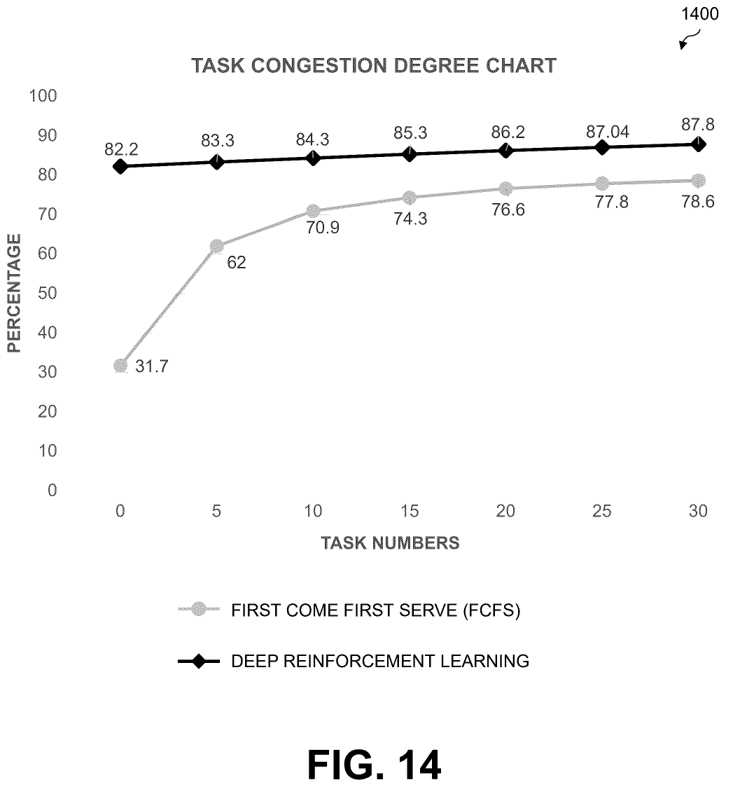

In another experiment, Agent2 works with Agent1 to schedule the backup operation tasks with dynamic resource allocation. Again, the performance of the trained deep reinforcement learning-based backup operation scheduling model is compared with the conventional FCFS approach for task congestion degree. The initial size of the backup servers (M) is set the same for FCFS, and a dynamic size (M′) is set for the trained deep reinforcement learning-based backup operation scheduling model. Task congestion degree reflects the number of backup operation tasks waiting for execution in the task queue at the end of each time slot. The task congestion degree is measured by the percentage of time slots in which the number of congested tasks is less than a certain benchmark number. Therefore, with a certain benchmark number, the less the congestion degree the better the scheduling algorithm works. FIG. 14 shows a plot 1400 of the statistical results. The change of task congestion degree with more benchmark numbers is visualized in the plot 1400, which shows that the congestion degree with the trained deep reinforcement learning-based backup operation scheduling model remains relatively stable and is better than the conventional FCFS approach with all benchmark numbers of congested tasks.

The technical solutions described herein provide a framework for building insights for backup operation execution prediction with intelligent recommendations by formulating the correlation between backup server workload and historical data for backup operations. Using deep reinforcement learning, a model will accurately predict the execution of backup operations on backup servers in an optimal or improved way. The technical solutions further leverage a predictive analyzer using deep reinforcement learning algorithms to create a virtual pool of backup servers with effective usage of resources, enabling sustainable computing that seeks to minimize or reduce resource utilization in the processing of backup operations.

In a backup infrastructure environment, backup operations are assigned to particular backup servers. When backup operations fail, it is often due to resource constraints of the backup infrastructure environment (e.g., the backup servers themselves, backend storage infrastructure on which the actual backed-up data is stored). The technical solutions provide an approach for optimizing or improving the scheduling of backup operations in a backup infrastructure environment, without requiring a one-by-one mapping and enabling assignment based on the availability of backup server resources through intelligent detection of available backup resources. Thus, the technical solutions are able to prioritize the execution of backup operations (e.g., backup job threads) against a pool of backup servers, through the use of a deep reinforcement learning model (e.g., which outputs actions such as “execute a given backup operation” or “wait for the next availability of a given backup server”) based on priority derived from environment metrics. The parameters considered for load factors include, for example, the number of threads running on backup servers, CPU resource metrics, memory resource metrics, historical backup operation run times, etc. These and other parameters or metrics may be obtained from IT infrastructure monitoring tools. A centralized backup database may maintain information related to historical backup operation run times. The deep reinforcement model may be trained (e.g., using six months of data) and tested against a current backup infrastructure environment. As shown in FIGS. 7 and 8, at time t, Agent 1 makes a decision as to whether to execute each task (e.g., backup operation) in the task queue 712. The scheduling action decision is denoted as a₁ₜ. After t seconds (at time \hat{t}), the system starts to optimize resource utilization. The backup servers 716 will turn on or off respective backup data domains according to the optimization decision a_{2\hat{t}} output by Agent2. Whenever time t comes, the system receives the tasks arriving from time t and stores such tasks in the task queue. Thus, the technical solutions advantageously provide a framework for building insights for backup operation execution prediction, with intelligent recommendations by formulating correlations between backup server workload and historical backup operation data. Using deep reinforcement learning, the technical solutions will accurately predict which backup operations to execute on which backup servers in an optimal or improved way. The predictive analytics, which leverage deep reinforcement learning, enables the creation of a virtual pool of backup servers with effective usage of resources, enabling sustainable computing practices that seek to minimize or reduce resource utilization in the processing of backup operations.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based management of backup operations will now be described in greater detail with reference to FIGS. 15 and 16. Although described in the context of system 100, these platforms may also be used to implement at least portions of other information processing systems in other embodiments.

FIG. 15 shows an example processing platform comprising cloud infrastructure 1500. The cloud infrastructure 1500 comprises a combination of physical and virtual processing resources that may be utilized to implement at least a portion of the information processing system 100 in FIG. 1. The cloud infrastructure 1500 comprises multiple virtual machines (VMs) and/or container sets 1502-1, 1502-2, . . . 1502-L implemented using virtualization infrastructure 1504. The virtualization infrastructure 1504 runs on physical infrastructure 1505, and illustratively comprises one or more hypervisors and/or operating system level virtualization infrastructure. The operating system level virtualization infrastructure illustratively comprises kernel control groups of a Linux operating system or other type of operating system.

The cloud infrastructure 1500 further comprises sets of applications 1510-1, 1510-2, . . . 1510-L running on respective ones of the VMs/container sets 1502-1, 1502-2, . . . 1502-L under the control of the virtualization infrastructure 1504. The VMs/container sets 1502 may comprise respective VMs, respective sets of one or more containers, or respective sets of one or more containers running in VMs.

In some implementations of the FIG. 15 embodiment, the VMs/container sets 1502 comprise respective VMs implemented using virtualization infrastructure 1504 that comprises at least one hypervisor. A hypervisor platform may be used to implement a hypervisor within the virtualization infrastructure 1504, where the hypervisor platform has an associated virtual infrastructure management system. The underlying physical machines may comprise one or more distributed processing platforms that include one or more storage systems.

In other implementations of the FIG. 15 embodiment, the VMs/container sets 1502 comprise respective containers implemented using virtualization infrastructure 1504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1500 shown in FIG. 15 may represent at least a portion of one processing platform. Another example of such a processing platform is processing platform 1600 shown in FIG. 16.

The processing platform 1600 in this embodiment comprises a portion of system 100 and includes a plurality of processing devices, denoted 1602-1, 1602-2, 1602-3, . . . 1602-K, which communicate with one another over a network 1604.

The network 1604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1602-1 in the processing platform 1600 comprises a processor 1610 coupled to a memory 1612.

The processor 1610 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1612 may comprise random access memory (RAM), read-only memory (ROM), flash memory or other types of memory, in any combination. The memory 1612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1602-1 is network interface circuitry 1614, which is used to interface the processing device with the network 1604 and other system components, and may comprise conventional transceivers.

The other processing devices 1602 of the processing platform 1600 are assumed to be configured in a manner similar to that shown for processing device 1602-1 in the figure.

Again, the particular processing platform 1600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based management of backup operations as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to identify a plurality of backup operations to be performed in a backup infrastructure environment, the backup infrastructure environment comprising two or more backup servers;
to generate a first data structure characterizing a prioritization of at least a subset of the plurality of backup operations;
to generate a second data structure characterizing status of the two or more backup servers in the backup infrastructure environment;
to determine, utilizing at least one machine learning model that is implemented by the at least one processing device and that takes as input at least a portion of the first data structure and at least a portion of the second data structure, an execution schedule for the subset of the plurality of backup operations; and
to execute the subset of the plurality of backup operations in the backup infrastructure environment in accordance with the determined execution schedule.

2. The apparatus of claim 1 wherein the backup infrastructure environment further comprises backup storage infrastructure, the two or more backup servers being configured to store data to be backed up on the backup storage infrastructure.

3. The apparatus of claim 1 wherein generating the first data structure comprises, for a given backup operation in the subset of the plurality of backup operations, determining a priority based at least in part on (i) a predicted execution time of the given backup operation and (ii) a waiting time of the given backup operation.

4. The apparatus of claim 1 wherein the at least one machine learning model comprises a reinforcement learning model.

5. The apparatus of claim 4 wherein the reinforcement learning model implements an actor-critic deep reinforcement learning algorithm.

6. The apparatus of claim 1 wherein the at least one machine learning model comprises a multi-agent reinforcement learning model comprising a first agent that takes as input the first data structure and a second agent that takes as input the second data structure.

7. The apparatus of claim 6 wherein the first agent of the multi-agent reinforcement learning model operates at first time intervals, and the second agent of the multi-agent reinforcement learning model operates at second time intervals.

8. The apparatus of claim 7 wherein a length of each of the second time intervals is a designated multiple of a length of each of the first time intervals.

9. The apparatus of claim 6 wherein:
the first agent of the multi-agent reinforcement learning model is associated with a first action space, a first state space and a first reward function; and
the second agent of the multi-agent reinforcement learning model is associated with a second action space, a second state space and a second reward function.

10. The apparatus of claim 6 wherein:
a first action space associated with the first agent of the multi-agent reinforcement learning model characterizes whether respective ones of the plurality of backup operations are allocated to one of the two or more backup servers for execution; and
a second action space associated with the second agent of the multi-agent reinforcement learning model characterizes whether respective ones of the two or more backup servers in the backup infrastructure environment are active.

11. The apparatus of claim 6 wherein:
a first state space associated with the first agent of the multi-agent reinforcement learning model characterizes execution times for ones of the plurality of backup operations that are allocated to one of the two or more backup servers for execution in the backup infrastructure environment; and
a second state space associated with the second agent of the multi-agent reinforcement learning model characterizes a sum of (i) the execution times for ones of the plurality of backup operations that are allocated to one of the two or more backup servers for execution in the backup infrastructure environment and (ii) execution times for ones of the plurality of backup operations that are not allocated to one of the two or more backup servers for execution in the backup infrastructure environment.

12. The apparatus of claim 11 wherein:
the first state space further characterizes priorities for ones of the plurality of backup operations that are allocated to one of the two or more backup servers for execution in the backup infrastructure environment; and
the second state space further characterizes a number of the plurality of backup operations arriving in a current time slot and a number of the plurality of backup operations not executed in a previous time slot.

13. The apparatus of claim 11 wherein:
the first state space further characterizes which of the two or more backup servers are active in a task scheduling time slot; and
the second state space further characterizes which of the two or more backup servers are active in a resource optimization time slot, the resource optimization time slot comprising two or more instances of the task scheduling time slot.

14. The apparatus of claim 6 wherein:
a first reward function associated with the first agent of the multi-agent reinforcement learning model is based at least in part on a first weighted sum of average priority of the plurality of backup operations in a task scheduling time slot and a proportion of the two or more backup servers that are active in the task scheduling time slot; and
a second reward function associated with the second agent of the multi-agent reinforcement learning model is based at least in part on a second weighted sum of average priority of the plurality of backup operations in a resource optimization time slot and a proportion of the two or more backup servers that are active in the resource optimization time slot, the resource optimization time slot comprising two or more instances of the task scheduling time slot.

15. A computer program product comprising a non-transitory processor-readable storage medium having stored therein program code of one or more software programs, wherein the program code when executed by at least one processing device causes the at least one processing device:
to identify a plurality of backup operations to be performed in a backup infrastructure environment, the backup infrastructure environment comprising two or more backup servers;
to generate a first data structure characterizing a prioritization of at least a subset of the plurality of backup operations;
to generate a second data structure characterizing status of the two or more backup servers in the backup infrastructure environment;
to determine, utilizing at least one machine learning model that is implemented by the at least one processing device and that takes as input at least a portion of the first data structure and at least a portion of the second data structure, an execution schedule for the subset of the plurality of backup operations; and
to execute the subset of the plurality of backup operations in the backup infrastructure environment in accordance with the determined execution schedule.

16. The computer program product of claim 15 wherein the at least one machine learning model comprises a multi-agent reinforcement learning model comprising a first agent that takes as input the first data structure and a second agent that takes as input the second data structure.

17. The computer program product of claim 16 wherein the first agent of the multi-agent reinforcement learning model operates at first time intervals, the second agent of the multi-agent reinforcement learning model operates at second time intervals, and a length of each of the second time intervals is a designated multiple of a length of each of the first time intervals.

18. A method comprising:
identifying a plurality of backup operations to be performed in a backup infrastructure environment, the backup infrastructure environment comprising two or more backup servers;
generating a first data structure characterizing a prioritization of at least a subset of the plurality of backup operations;
generating a second data structure characterizing status of the two or more backup servers in the backup infrastructure environment;
determining, utilizing at least one machine learning model that is implemented by at least one processing device and that takes as input at least a portion of the first data structure and at least a portion of the second data structure, an execution schedule for the subset of the plurality of backup operations; and
executing the subset of the plurality of backup operations in the backup infrastructure environment in accordance with the determined execution schedule;
wherein the method is performed by the at least one processing device comprising a processor coupled to a memory.

19. The method of claim 18 wherein the at least one machine learning model comprises a multi-agent reinforcement learning model comprising a first agent that takes as input the first data structure and a second agent that takes as input the second data structure.

20. The method of claim 19 wherein the first agent of the multi-agent reinforcement learning model operates at first time intervals, the second agent of the multi-agent reinforcement learning model operates at second time intervals, and a length of each of the second time intervals is a designated multiple of a length of each of the first time intervals.
